(19) United States
(12) Patent Application Publication
(10) Pub. No.: US 2025/0171963 A1
(43) Pub. Date: May 29, 2025

(54) SYSTEM AND METHOD FOR LAMINATING PAPER

(71) Applicant: Brown LLC, Beaverton, MI (US)

(72) Inventors: Koben James Miceli, Beaverton, MI (US); Jacob Michael Kowalewski, Beaverton, MI (US); Thomas A. Nalle III, Beaverton, MI (US)

(21) Appl. No.: 18/751,864

(22) Filed: Jun. 24, 2024

Related U.S. Application Data
(60) Provisional application No. 63/602,948, filed on Nov. 27, 2023.

(51) Int. Cl. D21J 3/00; B32B 29/00; B32B 37/06; B32B 37/10; B32B 37/12; B32B 38/00

(52) U.S. Cl. CPC D21J 3/00; B32B 29/005; B32B 37/06; B32B 37/10; B32B 37/1284; B32B 38/0004; B32B 2250/02; B32B 2250/26; B32B 2255/12; B32B 2439/70

(57) ABSTRACT

A system and method for forming a paper product from at least two layers of paper material. The system comprises a scoring station, a forming station, and a control station. The scoring station scores the at least two layers. The forming station comprises heating elements, opposing molds, and an actuator. The heating elements heat the molds via activation from the control system. The actuator is configured to actuate at least one of the heated molds against the layers via instructions from the control system to shape the paper product and melt the adhesive under pressure and heat. The actuator is also configured to remove at least one of the molds to separate the molds from the paper product so that the adhesive cools and bonds the layers together.

### RELATED APPLICATIONS

This regular utility non-provisional patent application claims priority benefit with regard to all common subject matter of U.S. Provisional Patent Application Ser. No. 63/602,948, filed Nov. 27, 2023, entitled “SYSTEM AND METHOD FOR LAMINATING PAPER”. The provisional patent application is hereby incorporated by reference in its entirety into the present patent application.

### BACKGROUND

Paper products often require layers of paper material to be pressed and shaped together for sufficient strength and rigidity. To that end, the layers may be bonded together via adhesives, but the bonded layers often separate or distort during pressing. Furthermore, bonding layers together before pressing requires a dedicated bonding station, which adds manufacturing costs and control complexity.

The background discussion is intended to provide information related to the present invention which is not necessarily prior art.

### SUMMARY

The present invention solves the above-described problems and other problems by providing a laminated paper pressware product forming system and method that integrates lamination and shape forming together. More particularly, the present invention provides a system and method for laminating layers of paper together during pressing in a forming station.

An embodiment is a laminated paper pressware product forming system broadly comprising a forming station and a control station. The forming station includes first and second molds for forming a product shape from layers of paper material having an adhesive applied thereto, a number of heating elements configured to heat the molds, and an actuator configured to press the molds against the paper material. The control system is configured to activate the heating elements thereby heating the molds and instruct the actuator to actuate the molds against the layers of paper material to apply pressure and heat to the layers. This melts the adhesive from a solid state to a liquid state between the layers of paper material as the product takes shape. The control system is also configured to instruct the actuator to remove the molds from the layers of paper material so that the adhesive cools to the solid state, thereby bonding the first and second layers of paper material together.

Another embodiment is a method of forming a laminated paper pressware product. The method broadly comprises steps of positioning at least two layers of paper material between opposing molds of a forming station and heating the opposing molds. The method further comprises a step of actuating the molds to press against the layers of paper material to apply pressure and heat to the layers of paper material. This melts the adhesive from a solid state to a liquid state between the layers of paper material. The layers of paper material are also shaped into a desired paper product. The method further comprises a step of removing the molds from the layers of paper material so that the adhesive cools to the solid state thereby bonding the layers of paper material together.

Another embodiment is a method of forming a laminated paper pressware product comprising steps of feeding layers of paper material from supply rolls via roller assemblies, pre-laminating the layers of paper material together, and scoring the layers of paper material. The method further comprises steps of positioning the layers of paper material between molds of a forming station and heating the molds. The method further comprises a step of actuating the molds to press against the layers of paper material to apply pressure and heat thereto. This melts the adhesive from a solid state to a liquid state between the layers of paper material. The layers of paper material are also shaped into a desired paper product. The method further comprises a step of removing the opposing molds from the layers of paper material so that the adhesive cools to the solid state thereby bonding the layers of paper material together.

### BRIEF DESCRIPTION OF THE DRAWING FIGURES

Embodiments of the present invention are described in detail below with reference to the attached drawing figures, wherein:

FIG. 1 is a perspective view of a system for producing pressware constructed in accordance with embodiments of the present invention;

FIG. 2 is a side elevation view of a material feed station of the system of FIG. 1;

FIG. 3 is a perspective view of a scoring station of the system of FIG. 1;

FIG. 4 is a perspective view of a forming station of the system of FIG. 1;

FIG. 5 is an elevated perspective view of a forming tool of the forming station of FIG. 12 with molds having draw rings;

FIG. 6 is a lowered perspective view of the forming tool of FIG. 5;

FIG. 7 is a sectional view of the forming tool of FIG. 5 along lines 15-15;

FIG. 8 is a perspective view of a positive mold of the forming tool of FIG. 5;

FIG. 9 is a top view of the positive mold of FIG. 8;

FIG. 10 is a sectional view of the positive mold of FIG. 8;

FIG. 11 is an enlarged view of the forming tool of FIG. 5 with the positive mold extending into a corresponding negative mold;

FIG. 12 is an enlarged view of portions of the positive mold and the negative mold of FIG. 11;

FIG. 13 is a sectional view of the forming tool of FIG. 5 along lines 15-15 with positive molds constructed according to another embodiment of the present invention;

FIG. 14 is a perspective view of a picking station, stacking station, and chopping station of the system of FIG. 1;

FIG. 15 is a perspective view of the chopping station of FIG. 14;

FIG. 16 is a block diagram depicting selected components of the system of FIG. 1;

FIG. 17 is a flowchart depicting exemplary steps of a method according to an embodiment of the present invention; and

FIG. 18 is a flowchart depicting exemplary steps of a another method according to an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

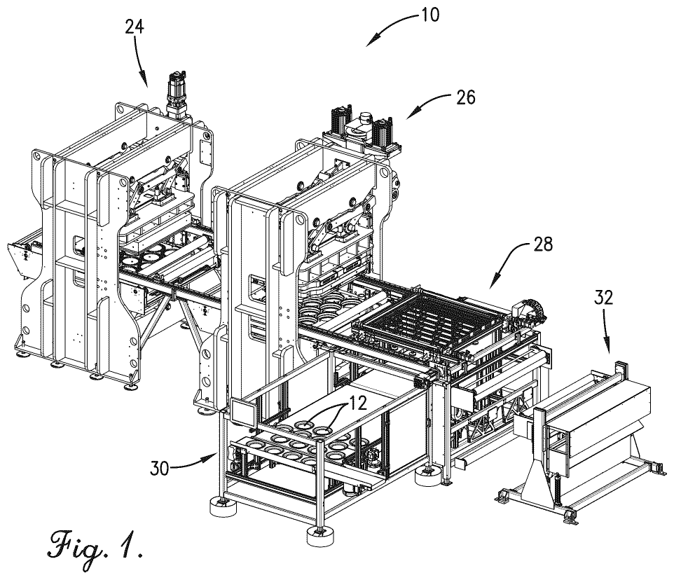

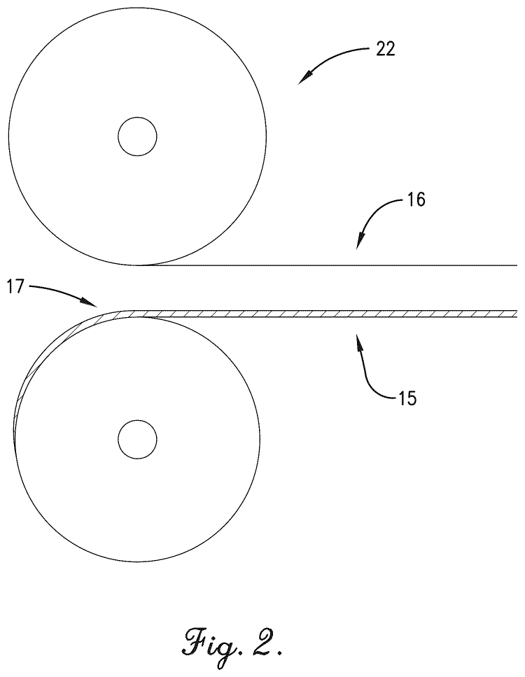

Turning to FIGS. 1 and 2, a laminated paper pressware product forming system (hereinafter “system 10”) constructed in accordance with an embodiment of the invention is illustrated. The system 10 is configured to form laminated paper pressware products 12 (hereinafter “products 12”) such as plates, bowls, trays, food delivery boxes, and the like from two or more layers 15, 16 of material.

The layers 15, 16 of material may comprise paper, polystyrene, recycled paper, vegetable or organic matter, cotton, bamboo, or the like. One of the layers 15, 16 may be coated with a thermal reactive/thermally activated adhesive 17 coating one side thereof as described in more detail below.

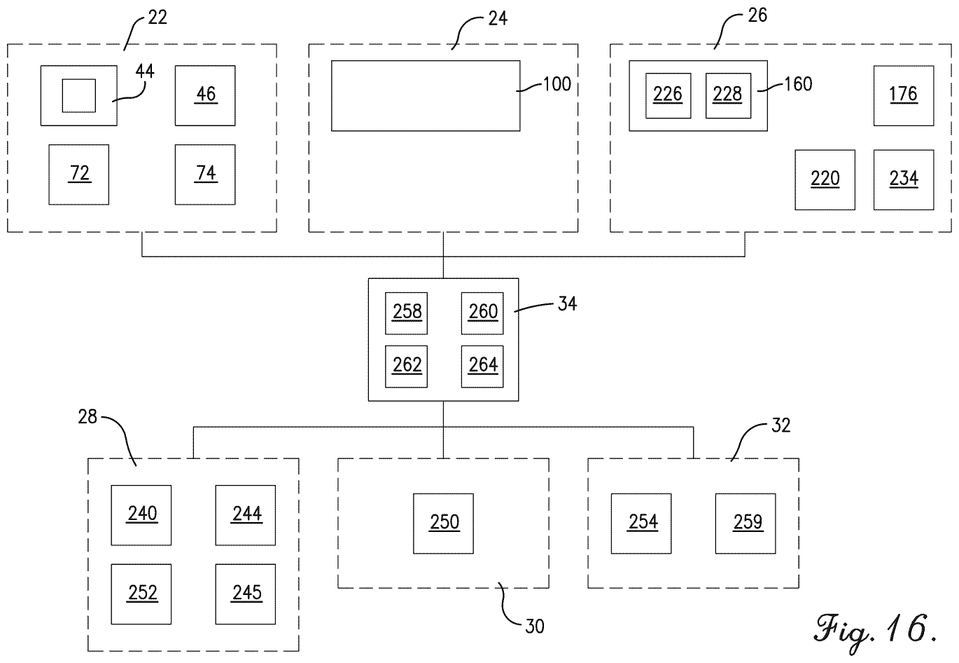

An embodiment of the system 10 broadly comprises a material feed station 22 (FIG. 2), an optional coating station (if neither of the layers 15, 16 are already coated with adhesive 17), a scoring station 24, a forming station 26, a picking station 28, a stacking station 30, a chopping station 32, and a control system 34 (schematically depicted in FIG. 16).

Turning to FIG. 2, the material feed station 22 is configured to provide the layers 15, 16 of material from supply rolls. The material feed station 22 may include a material feed station actuator 44, a sensor 46, and drive motors 72, 74 (schematically depicted in FIG. 16). The drive motors 72, 74 rotate rollers to pull the layers 15, 16 from their respective supply rolls.

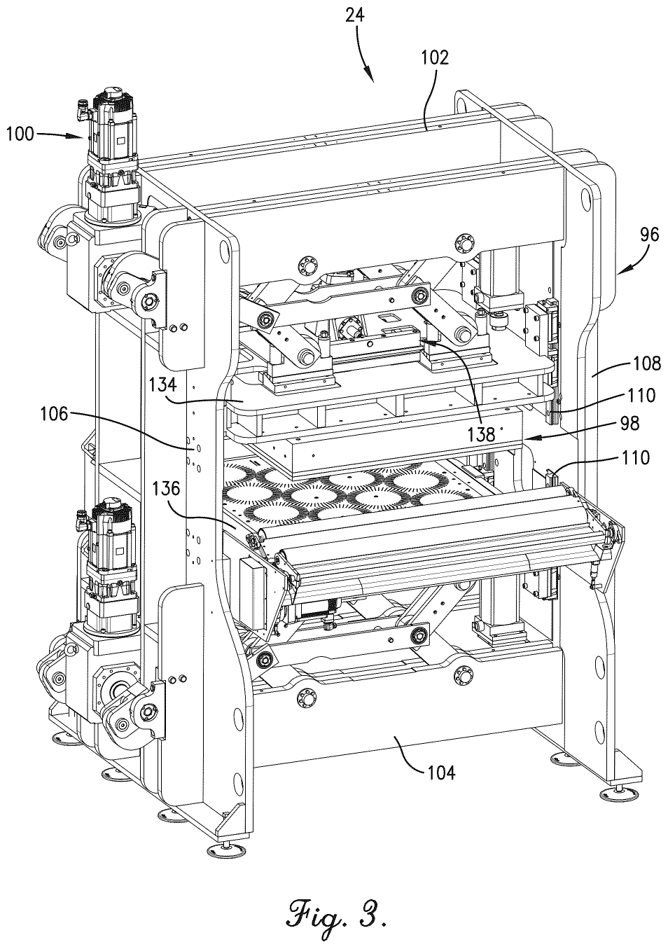

Turning to FIG. 3, the scoring station 24 scores the layers 15, 16 in preparation of forming the products 12. The scoring station 24 may comprise a scoring station frame 96, a scoring tool 98, and a scoring station actuator 100. The scoring station frame 96 is configured to support the scoring tool 98 and the scoring station actuator 100. The frame 96 may include an upper gantry 102, a lower gantry 104, and upright supports 106, 108. The gantries 102, 104 support different portions of the scoring tool 98 and the scoring station actuator 100. The upright supports 106, 108 support the gantries 102, 104 and may include one or more tracks 110 for guiding the scoring tool 98 and or portions of the actuator 100.

The scoring tool 98 may be configured to be pressed against the layers 15, 16 to score the layers 15, 16 simultaneously. Alternatively, the layers 15, 16, may be scored independently or in succession. The scoring tool 98 may include a top tool and a bottom tool. The top tool may include a top die plate, a punch backing plate secured to the top die plate, a punch holder secured to the punch backing plate, and a plurality of scoring punches secured by the punch holder. The punches may include blades that extend beyond the punch holder and are operable to impart slots in the layers 15, 16.

The bottom tool may include a bottom die plate and a striker plate secured to the bottom die plate. The striker plate may include a plurality of scoring slots that are complementary to the blades of the top tool. The punches and their blades and the corresponding slots may extend about a shape representing an outline of the pressware products 12. The punches and slots may extend radially away from the shape. However, the punches and slots may extend along the outline of the shape any number of ways without departing from the scope of the present invention. Further, the punches may be pointed to impart holes instead of slots without departing from the scope of the present invention. There may be any number of punches for producing any number of slots about the shape (which may be any suitable shape) without departing from the scope of the present invention.

The scoring station actuator 100 may be configured to shift the scoring tool 98 and may include a top platen and a bottom platen. The top tool may be secured to the top platen which may be vertically shiftable along the tracks 110 of the frame 96. The bottom tool may be secured to the bottom platen and also vertically shiftable and guided via the tracks 110. The top platen may be secured to the height adjust assembly for providing adjustments to the scoring depth of the punches.

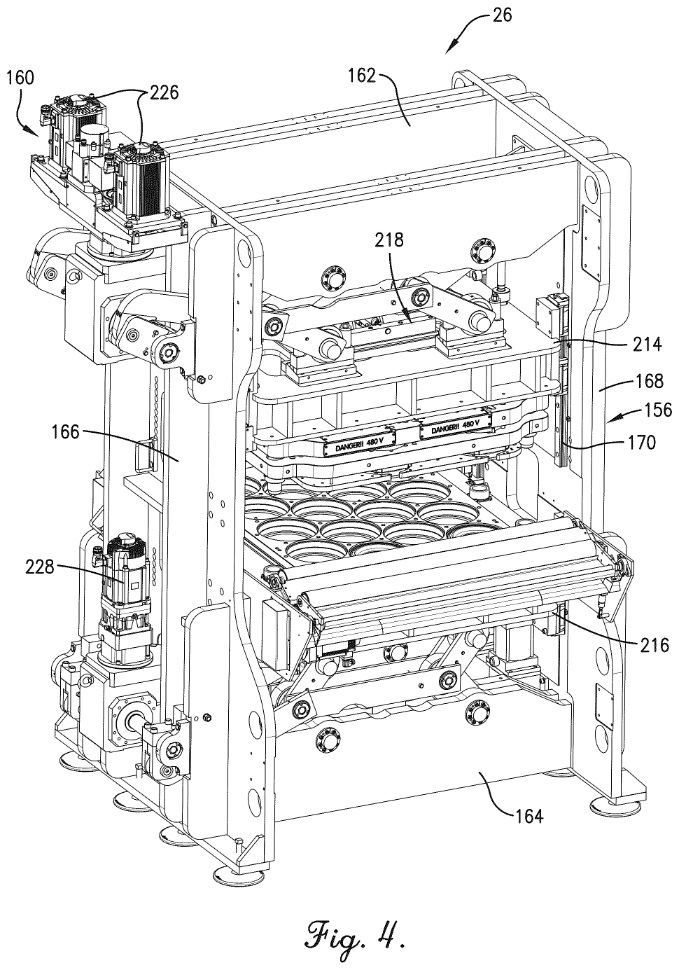

Turning to FIGS. 4-7, the forming station 26 may be configured to punch scored shapes out of the layers 15, 16 and form the products 12. The forming station 26 may comprise a forming station frame 156, a forming tool 158, and a forming station actuator 160. The forming station frame 156 is configured to support the forming tool 158 and the forming station actuator 160. The frame 156 may include an upper gantry 162 and a lower gantry 164 for supporting different portions of the forming tool 158 and the forming station actuator 160 and upright supports 166, 168 for supporting the gantries 162, 164. The upright supports 166, 168 may include one or more tracks 170 for guiding the forming tool 158 and or portions of the actuator 160. The forming station 26 may include one or more force sensors 234 (shown schematically in FIG. 16) for detecting a force applied to the layers 15, 16 by the forming tool 158.

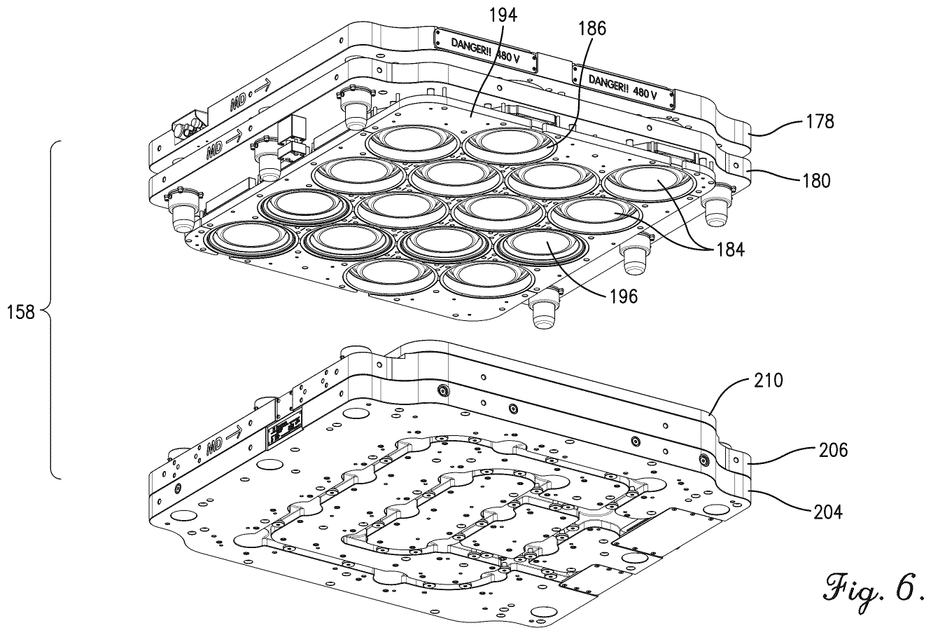

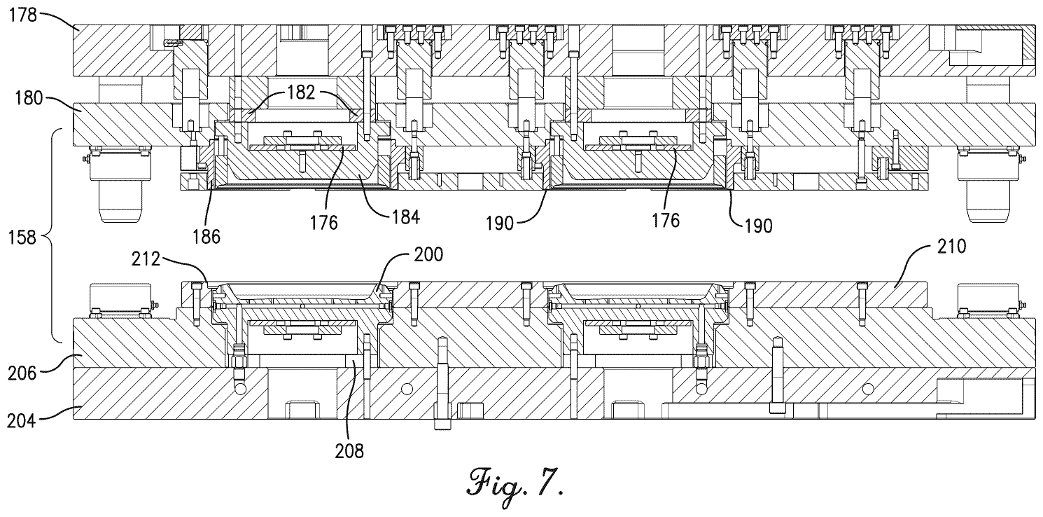

The forming tool 158 may be configured to be actuated to punch out the scored shapes and form the products 12. The forming tool 158 may include a positive mold assembly 172, a negative mold assembly 174, and heating elements 176. As depicted in FIGS. 6 and 7, the positive mold assembly 172 may include a positive mold shoe 178, a punch shoe 180, an insulator plate 182 (shown in FIG. 7), a plurality of molds 184, and a plurality of punches 186. The positive mold shoe 178 supports the plurality of molds 184, and the punch shoe 180 supports the punches 186. Some of the heating elements 176 may be positioned on and secured to the molds 184, and particularly to the top surfaces of the molds 184, to heat the molds 184 and in turn heat the layers 15, 16 to form the products 12. The insulator plate 182 may be positioned above the heated molds 184 to insulate portions of the positive mold assembly 172 from the heated molds 184.

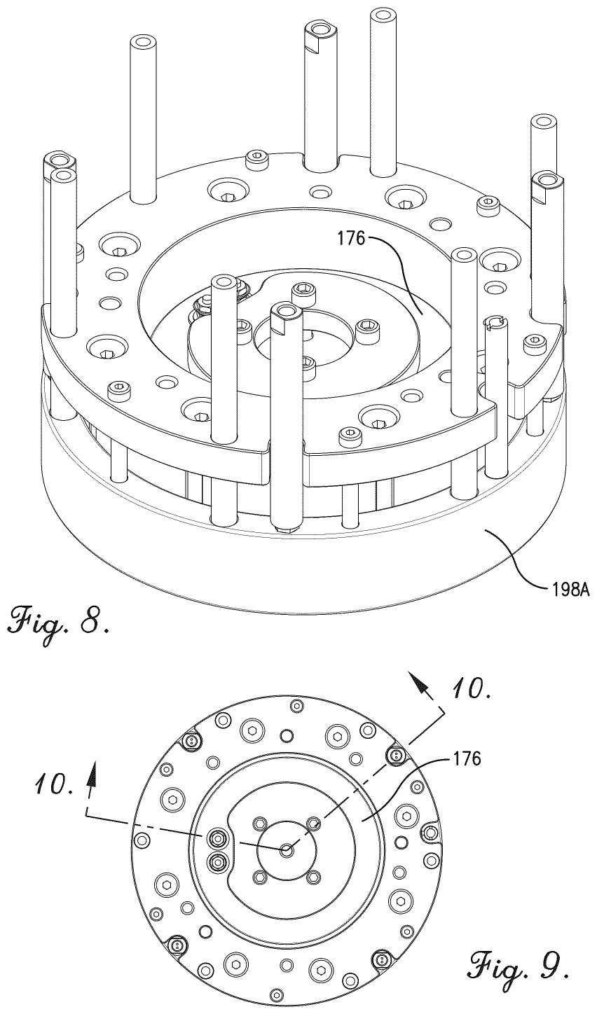

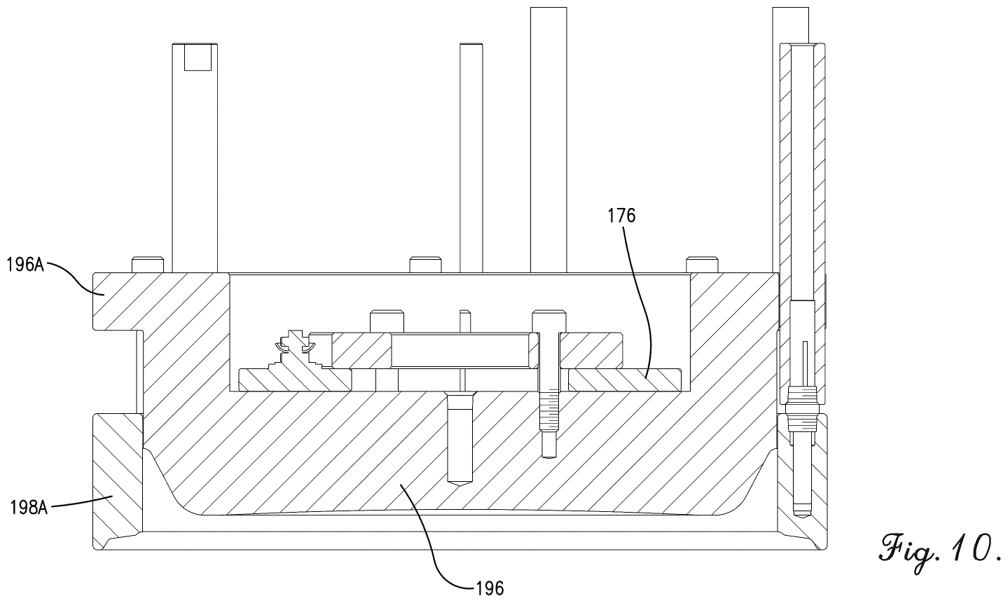

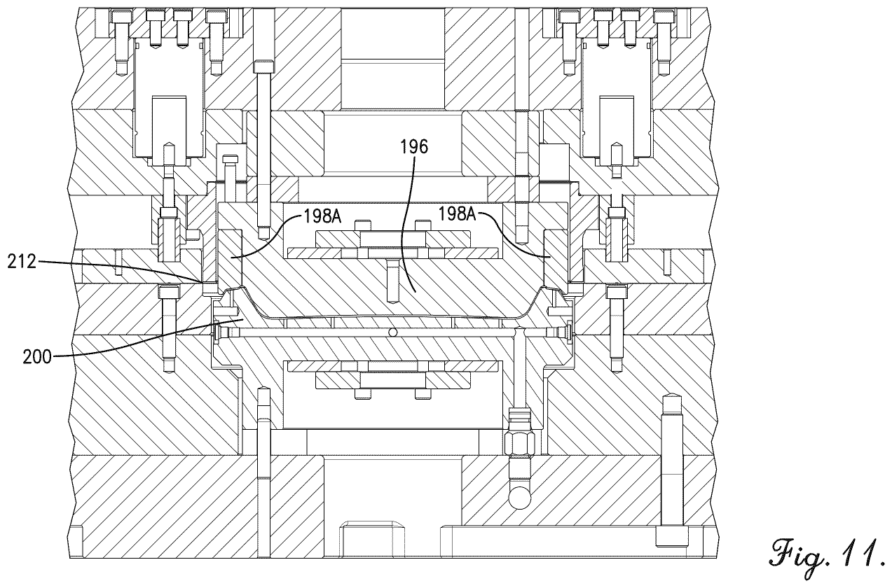

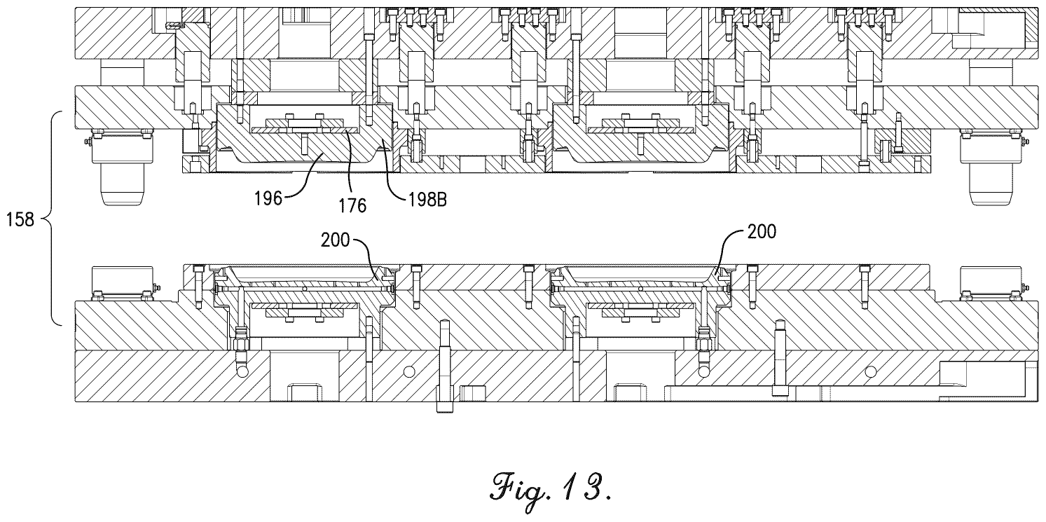

Turning to FIGS. 8-13, the molds 184 may include bottom surfaces 188 for forming top surfaces of the products 12. The molds 184 of the positive mold assembly 172 may include central portions 196 and annular portions 198A,B. In some embodiments, the annular portions 198A may be draw rings that are shiftable relative to the central portions 196. The central portions 196 may include flanges 196A that push down on the annular portions 198A to compress the rim of the products 12 to increase the rigidity of the rim of the products 12. However, temperatures of the annular portions 198A and the central portions 196 may need to be monitored and regulated to avoid thermal expansion issues (such as friction, scraping, wearing, and jamming) between the shifting annular portions 198A and the central portions 196. Thus, in some embodiments, to enable higher forming temperatures of the products 12, the molds 184 may include annular portions 198B that are integral to the central portions 196.

The punches 186 may include edges 190 (FIG. 7) configured to cut the shapes from the layers 15, 16. Additionally, the forming tool 158 may include nitrogen gas springs configured to help press the punches 186 against the layers 15, 16. The positive mold assembly 172 may also include a trim stripper for pushing scrap material (discussed further below) away from the positive mold assembly 172.

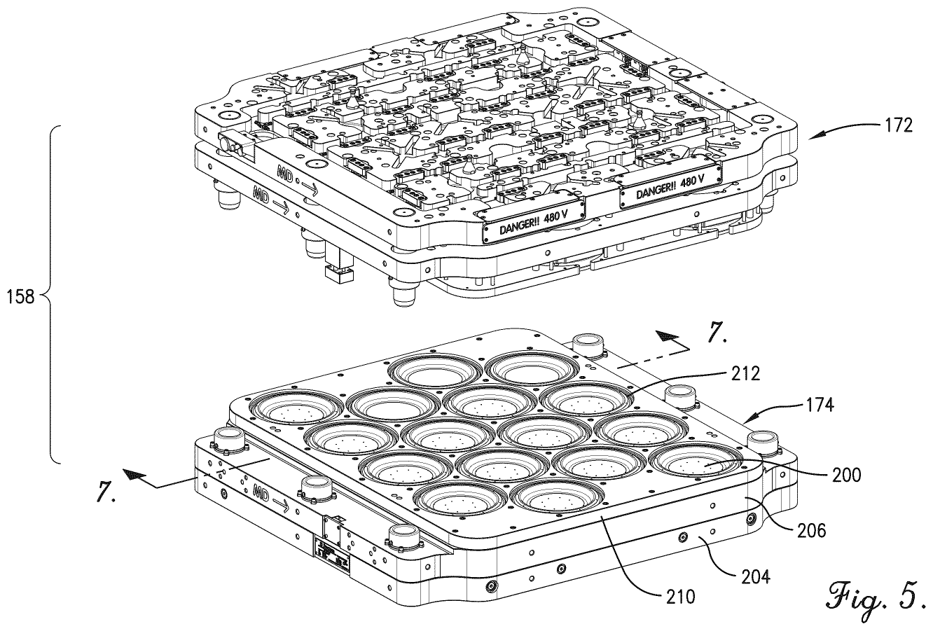

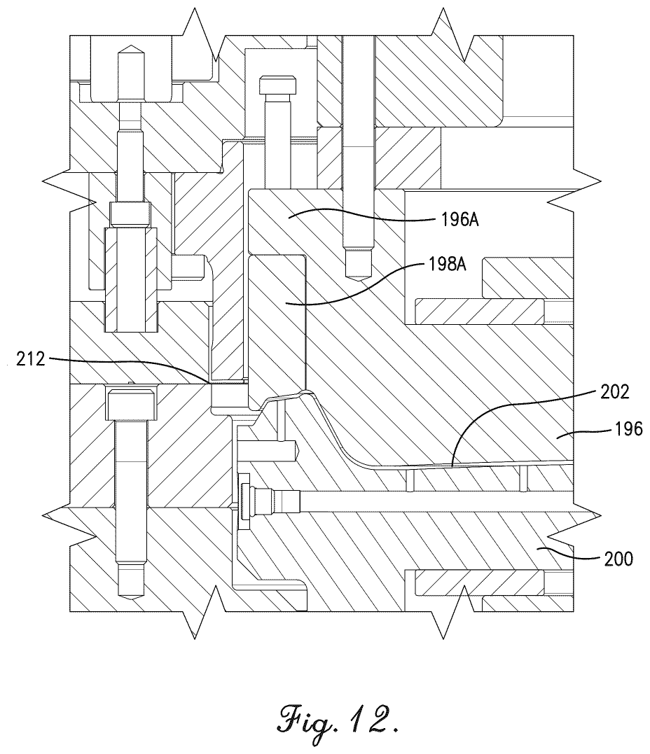

Referring again to FIG. 5, the negative mold assembly 174 may include negative molds 200 with top surfaces 202 (FIG. 12) for forming bottom surfaces of the pressware products 12, a negative mold shoe 204, a die shoe 206, an insulator plate 208 (FIG. 7), and a trim die 210. The negative molds 200 may be complementary to the positive molds 184 and may be secured to the negative mold shoe 204. The die shoe 206 may be secured to the negative mold shoe 204, and the trim die 210 may secured to the die shoe 206. The trim die 210 may include edges 212 that pinch the layers 15, 16 with the punches 186 of the positive mold assembly 172 to remove the products 12 from the surrounding material. Some of the heating elements 176 may also be secured to the bottom surfaces of the negative molds 200 to heat the molds 200 and in turn help heat the layers 15, 16 to form the products 12. The insulator plate 208 may be positioned below the heated molds 200 to insulate portions of the negative mold assembly 174 from the heated molds 200.

Turning back to FIG. 4, the forming station actuator 160 may be configured to actuate the forming tool 158 and may include a top platen 214, a bottom platen 216, a top platen servo drive 226, and a bottom platen servo drive 228. The positive mold assembly 172 may be secured to the top platen 214 which is vertically shiftable and guided by the tracks 170 of the frame 156. The negative mold assembly 174 may be secured to the bottom platen 216 and also vertically shiftable and guided by the tracks 170. The top platen 214 may be secured to the height adjust assembly 218 for providing adjustments to the depth of the molds 184.

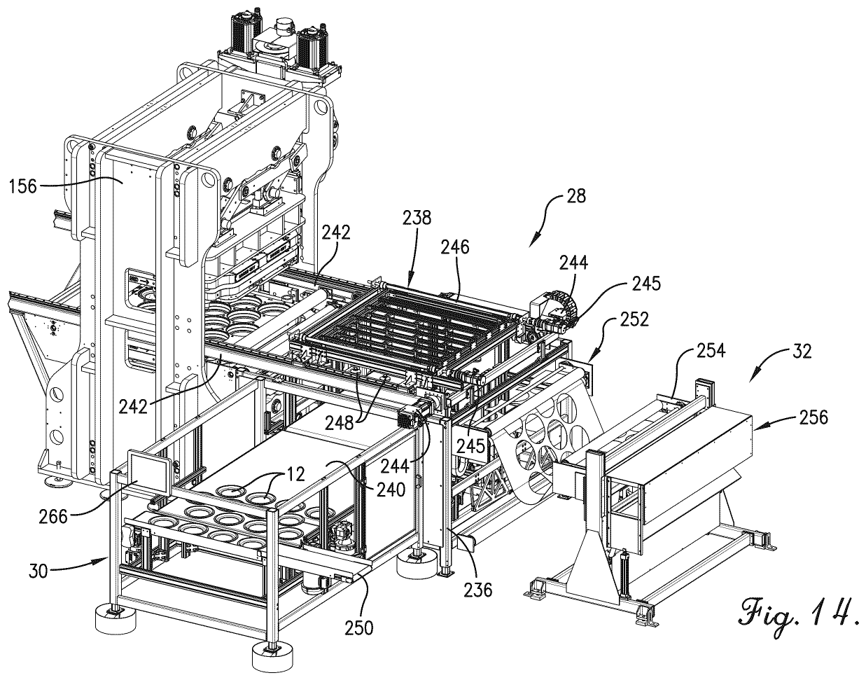

Turning to FIG. 14, the picking station 28 may be configured to pick the products 12 from the bottom molds 200. The picking station 28 may include a frame 236, a vacuum cup extractor assembly 238, and a conveyor 240. The frame 236 may be adjacent to the forming station 26 so that the picking station 28 receives scrap material from the forming station 26 and can access the products 12 formed at the forming station 26.

The vacuum cup extractor assembly 238 may be supported on the frame 236 and include tracks 242, actuators 244, 245 a shiftable frame 246, and a plurality of vacuum cups 248. The tracks 242 may be secured to the frame 236 and extend onto the frame 156 of the forming station 26. The actuators 244 are configured to move the shiftable frame 246 along the tracks 242 to shift the frame 246 above the negative mold assembly 174 of the forming station 26 and back to the frame 236 of the picking station 28. The actuators 245 are configured to lower the frame 246 so that the vacuum cups 248 engage the products 12. The shiftable frame 246 supports the plurality of vacuum cups 248 as it shifts along the tracks 242. The frame 236 and/or the vacuum cups 248 may be vertically shiftable so that the cups 248 can move toward the negative mold assembly 174 to engage the products 12, pull the products 12 up out of the molds 200, and move them above the conveyor 240. The vacuum cups 248 may be configured to releasably hold the products 12.

The conveyor 240 may be positioned below the tracks 242 on the frame 236 and be configured to transport the products 12 dropped by the vacuum cup extractor assembly 238 to the stacking station 30. The stacking station 30 may include a transverse conveyor 250 that receives rows of the products 12 from the conveyor 240 of the picking station 28 and transports each row transversely to a bin causing the rows of products 12 to stack in the bin.

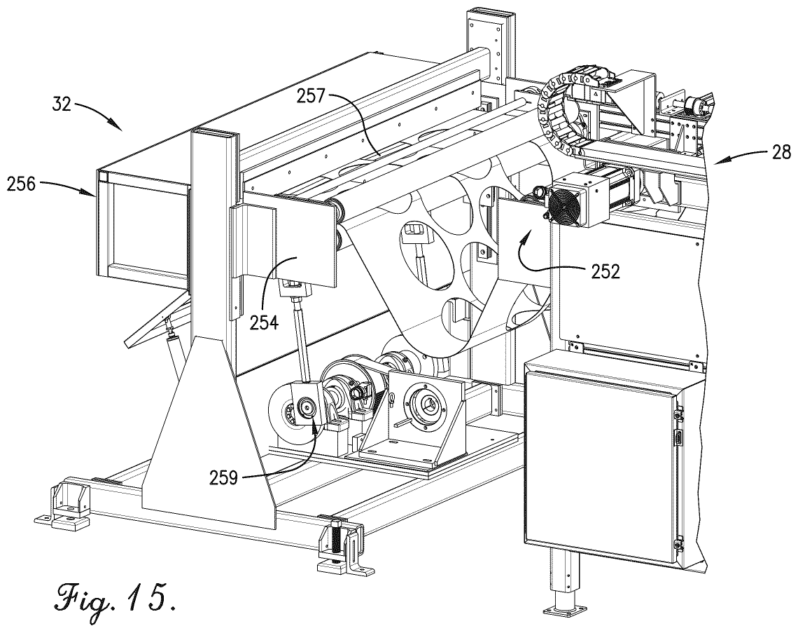

The picking station 28 may further include an indexer 252 for transporting scrap material to the chopping station 32. The chopping station 32 may include an indexer 254 that receives and/or pulls the scrap material into a scrap chopper 256. Turning to FIG. 15, the scrap chopper 256 may include an edge 257 for cutting the scrap material and an actuator 259 for actuating the edge 257 so that it presses against the scrap material to cut the scrap material into two or more pieces. The edge 257 may comprise any cutting device without departing from the scope of the present invention, including a knife, cutting blades attached to a rotating shaft (similar to a paper shredder), or the like.

Turning to FIG. 16, various components of the system 10 may be controlled by and/or in communication with the control system 34. The control system 34 may comprise a communication element 258, a memory element 260, a user interface 262, and a processing element 264. The communication element 258 may generally allow communication with systems or devices external to the system 10. The communication element 258 may include signal or data transmitting and receiving circuits, such as antennas, amplifiers, filters, mixers, oscillators, digital signal processors (DSPs), and the like. The communication element 258 may establish communication wirelessly by utilizing RF signals and/or data that comply with communication standards such as cellular 2G, 3G, 4G, 5G, or LTE, WiFi, WiMAX, Bluetooth®, BLE, or combinations thereof. The communication element 258 may be in communication with the processing element 264 and the memory element 260.

The memory element 260 may include data storage components, such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 260 may be embedded in, or packaged in the same package as, the processing element 264. The memory element 260 may include, or may constitute, a “computer-readable medium”. The memory element 260 may store the instructions, code, code segments, software, firmware, programs, applications, apps, services, daemons, or the like that are executed by the processing element 264.

The user interface 262 generally allows the user to utilize inputs and outputs to interact with the system 10 and is in communication with the processing element 264. Inputs may include buttons, pushbuttons, knobs, jog dials, shuttle dials, directional pads, multidirectional buttons, switches, keypads, keyboards, mice, joysticks, microphones, or the like, or combinations thereof. The outputs of the present invention include a display 266 (depicted in FIG. 14) but may include any number of additional outputs, such as audio speakers, lights, dials, meters, printers, or the like, or combinations thereof, without departing from the scope of the present invention.

The processing element 264 may include processors, microprocessors (single-core and multi-core), microcontrollers, DSPs, field-programmable gate arrays (FPGAs), analog and/or digital application-specific integrated circuits (ASICs), or the like, or combinations thereof. The processing element 264 may generally execute, process, or run instructions, code, code segments, software, firmware, programs, applications, apps, processes, services, daemons, or the like. The processing element 264 may also include hardware components such as finite-state machines, sequential and combinational logic, and other electronic circuits that can perform the functions necessary for the operation of the current invention. The processing element 264 may be in communication with the other electronic components through serial or parallel links that include address buses, data buses, control lines, and the like.

For example, the processing element 264 of the control system 34 may be in communication with the material feed station actuator 44, the material feed station sensor 46, the material feed station motors 72, 74, the scoring station actuator 100, the forming station actuator 160, the forming station heating elements 176, the forming station force sensors 234, the picking station conveyor 240, the vacuum cup assembly actuators 244, 245, the stacking station conveyor 250, the scrap chopper 256 (and its actuator 259), and/or other components or sensors. The processing element 264 may be in communication with the above components via the communication element 258 and/or direct wiring. The processing element 264 may be configured to send and/or receive information, data, commands, or the like to and/or from the above components. For example, the processing element 264 may be configured to direct the material feed station motors 72, 74 to pull the layers 15, 16 from the rolls of material. As another example, the processing element 264 may be configured to receive sensor data from the material feed station sensor 46.

The processing element 264 may be configured to direct the scoring station actuator 100 to shift the scoring tool 98 to score the layers 15, 16. The processing element 264 may be configured to direct the scoring station actuator 100 to shift the scoring tool 98 to a predetermined scoring depth. Further, the processing element 264 may be configured to receive a new predetermined scoring depth (for example, from the user interface 262) and direct the actuator 100 to shift the scoring tool 98 to the new predetermined scoring depth for each stroke.

The processing element 264 may be configured to direct the forming station 26 to position the layers 15, 16 between the mold assemblies 172, 174 so that scored portions of the layers 15, 16 are aligned with the molds 184, 200 of the mold assemblies 172, 174. The processing element 264 may be configured to direct the forming station actuator 160 (or the servo drive motors 226, 228) to shift the mold assemblies 172, 174 to a forming position at a predetermined forming depth, whereby the punches 186 separate the shapes from the layers 15, 16. The processing element 264 may be configured to adjust the forming depth by directing the drive motors 226, 228 or directing the servo motor 220 of the forming station height adjust assembly 218. The processing element 264 may be configured to receive a forming compression force detected by the force sensors 234, and direct the servo motors 226, 228 and/or the servo motor 220 so that the forming compression force remains at or below a predetermined forming compression force. The processing element 264 may also be configured to activate the heating elements 176 so that the molds 184, 200 are heated and therefore the corresponding portions of the layers 15, 16 are heated. The processing element 264 may be configured to direct the forming station drive motors 226, 228 to hold the molds 184, 200 at their forming position for a predetermined amount of time. The processing element 264 may then direct the motors 226, 228 to shift open to allow the formed products 12 to be picked by the picking station 28.

The processing element 264 may further be configured to direct the picking station actuators 244, 245 to shift the shiftable frame 246 so that the suspended vacuum cups 248 are positioned over the formed products 12. The processing element 264 may be configured to direct the actuator 245 to lower the cups 248 so that they engage the products 12, lift the cups 248 so that the cups 248 pull the products 12 away from the surrounding scrap material, and shift the cups 248 and products 12 to a position above the conveyor 240. The processing element 264 may be configured to cause the cups 248 to disengage the products 12 so that the products 12 fall onto the conveyor 240.

The processing element 264 may further be configured to direct the conveyor 240 to activate so that the products 12 are transported to the transverse conveyor 250, which the processing element 264 may also cause to be activated so that the products 12 are stacked in a bin (not shown). Further, the processing element 264 may be configured to direct indexers to pull the scrap material into the scrap chopper 256 and to direct the scrap chopper actuator 259 to actuate the edge 257 to cut the scrap material.

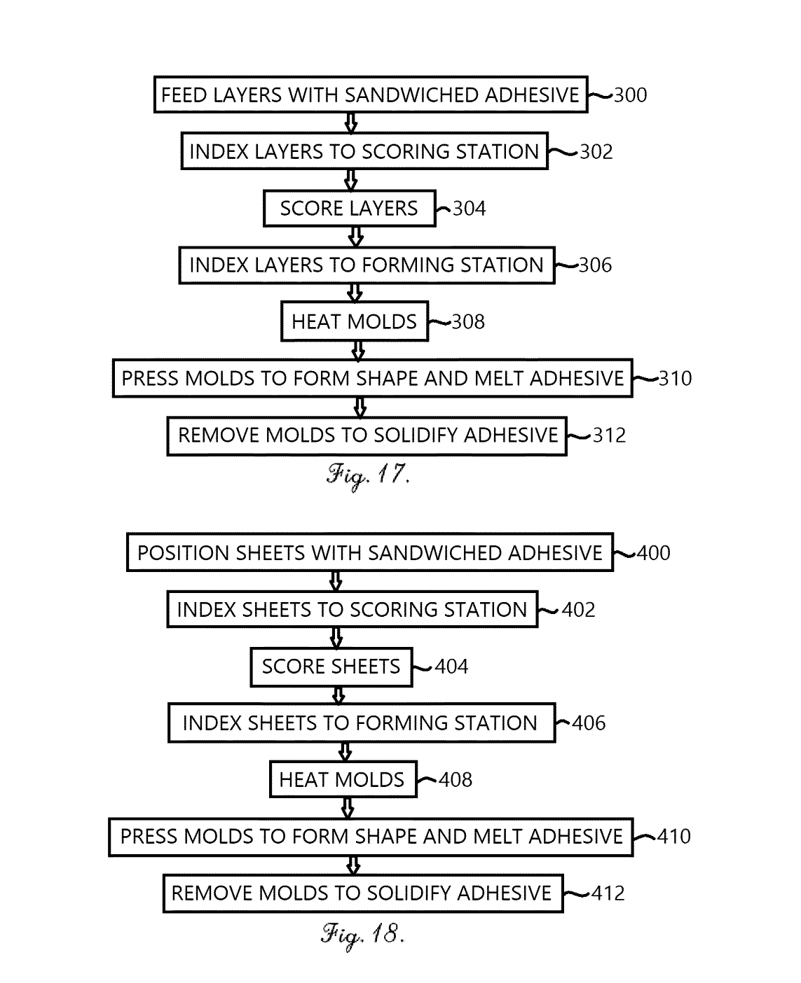

Turning to FIG. 17, a method of laminating paper material will now be described in more detail. First, multiple layers (e.g., two layers 15, 16) of paper may be fed one on top of the other from supply rolls via roller assemblies, as shown in block 300. One or both of the layers 15, 16 may have a thermal reactive/thermally activated adhesive 17 coated on one side thereof, which may be previously applied. The layers 15, 16 may be positioned with the adhesive 17 sandwiched between the layers 15, 16.

The layers 15, 16 may be “pre-laminated” at certain spots or areas prior to scoring. Such pre-laminations may help the layers 15, 16 remain aligned during the indexing from the upstream station(s) to the forming station 26. The pre-laminations could be positioned at or near the center of the shape of the product being formed. This may help keep the blank(s) aligned in the mold after they are cut from the sheets by the punch and die. This may also allow the layers 15, 16 to move evenly during the forming process since the bonded spot is located at or near the center of the shape. It could also be determined that the pre-laminations might be best located at a position other than the center depending on the shape and properties of the product being formed.

It may also be possible to pre-laminate the layers 15, 16 together at or prior to the scoring station 24 by bonding them in the scrap areas around the blank shapes to be cut in the forming station 26. This may allow the layers 15, 16 to remain aligned during indexing into the forming station 26 without any pre-laminating of the blanks that will form the final product shape.

Alternatively, the layers 15, 16 may be pre-laminated prior to the forming station 26 when no scoring operation is being preformed. In such a case, the shape and depth of the product being formed may not require any scoring lines to be pressed into the layers 15, 16.

As yet another alternative, the layers 15, 16 may be mechanically attached together in scrap areas without using heat. A feature could be pressed, cut, or punched into the layers 15, 16 that may allow them to mechanically connect and remain aligned during downstream indexing.

The layers 15, 16 may be indexed to the scoring station 24, as shown in block 302. At the scoring station 24, score lines may be pressed into the layers 15, 16 simultaneously, as shown in block 304.

The scored layers 15, 16 may then be indexed to the forming station 26, as shown in block 306. To that end, registration should be maintained and the score lines should match between the layers 15, 16. The heating elements 176 may heat the molds 184, 200 of the positive mold assembly 172 and the negative mold assembly 174, as shown in block 308. The positive mold assembly 172 and the negative mold assembly 174 of the forming tool 158 may then press the heated molds 184, 200 against the layers 15, 16 to form the desired shape of the products 12, as shown in block 310. The heat from the heated molds 184, 200 help form and set the paper shape and heat the adhesive 17.

Once the required temperature of the compressed and formed layers 15, 16 has reached a melting point of the adhesive 17, the adhesive 17 melts from a solid state to a liquid/viscous state. The liquid adhesive 17 thereby becomes a bonding agent between the layers 15, 16.

The molds 184, 200 may then be opened to remove the heat and pressure from the formed layers 15, 16, as shown in block 312. The temperature of the adhesive 17 thus reduces so that the adhesive 17 returns from the liquid state to the solid state. This completes the bonding of the layers 15, 16. In one embodiment, forming the shape of the product 12 may be achieved first under the pressure and heat of the forming tool 158. Complete melting of the adhesive 17 may be achieved after the product shape has been formed. Final bonding may be achieved after the adhesive 17 has cooled to the solid state and after the product shape has been formed.

Turning to FIG. 18, a method of laminating sheets of paper material will now be described in more detail. Two or more sheets of paper may be positioned one on top of the other(s), as shown in block 400. One or more of the sheets may have a coating applied in a prior process that can act as a thermal reactive adhesive that can go from a solid state to a liquid/viscous state after being heated to a certain temperature. The sheets may be positioned with the adhesive coating sandwiched between the layers. The adhesive coating can be applied to either one or both sides of the contacting paper sheets.

The layered sheets may be indexed to the scoring station 24 (block 402) where score lines may be pressed into them simultaneously (block 404). The scored sheets may then be indexed into the forming station 26 with registration being maintained and the scoring lines matched between the layered sheets, as shown in block 406.

The mold assemblies 172, 174 may be heated via heating elements 176, as shown in block 408. Once the layered sheets are in the forming station 26, the mold assemblies 172, 174 may close against the sheets and form the shape of the container/product under pressure, as shown in block 410. The heat from the tooling used to help form and set the paper shape may also heat the adhesive coating(s). Once the required temperature of the compressed and formed paper layers have reached the melting point of the adhesive coating, the coating material melts (i.e., converts from a solid to a liquid state). The liquid adhesive coating material thus becomes a bonding agent between the layers.

The mold assemblies 172, 174 may then be opened thus removing the heat and pressure from the formed layers of paper, as shown in block 412. The adhesive coating material temperature then reduces with the adhesive material returning to a solid state as it cools completing the bonding of the layered paper sheets.

A critical point to note is that the forming of the shape of the container/product may be achieved first under the pressure and temperature of the tooling. The complete melting of the adhesive may come after the container/product shape forming has been achieved. The final bonding may then come after the adhesive has cooled back to a solid state after the forming of the shape has been fully achieved.

Another possible step in the process may be to pre-laminate a small spot or area of the sheets prior to or during the scoring process. This small laminated spot may help the sheets remain aligned during the indexing from the upstream station(s) to the forming station 26.

The pre-laminated spot could be positioned at or near the center of the shape of the product being formed. This may help keep the blank(s) aligned in the mold after they are cut from the sheets by the punch and die. This may also allow the sheets to move evenly during the forming process since the bonded spot is located at or near the center of the shape. It could also be determined that the pre-laminated spot might be best located at a position other than the center depending on the shape and properties of the product being formed.

It may also be possible to pre-laminate the sheets together at or prior to the scoring station 24 by bonding them in the scrap areas around the blank shapes to be cut in the forming station 26. This may allow the sheets to remain aligned during indexing into the forming station without any pre-laminating of the blanks that will form the final product shape.

Alternatively, the sheets may be pre-laminated prior to the forming station 26 when no scoring operation is being preformed. The shape and depth of the product being formed may not require any scoring lines to be pressed into the sheets.

As yet another alternative, the sheets may be mechanically attached together in the scrap areas without using heat. For example, a feature could be pressed, cut, or punched into the paper layers that may allow them to mechanically connect and remain aligned during downstream indexing.

The above-described invention provides several advantages. For example, layers of paper may be laminated together during pressing in a forming station, which simplifies and streamlines production. This also may reduce the number of stations or components in a production line. By integrating lamination with forming, lamination may be more precisely controlled via the control system 34, thus resulting in a more consistent and accurate lamination. Furthermore, the layers of paper do not separate or distort during pressing because they are not fully bonded until after pressing.

### ADDITIONAL CONSIDERATIONS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth in any subsequent regular utility patent application. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims included in any subsequent regular utility patent application a non are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention.

Having thus described various embodiments of the invention, potentially patentable subject matter may include the following:

1. A system for forming a laminated paper pressware product from at least two layers of paper material, at least one of the two layers of paper material having an adhesive applied thereto, the system comprising:
a forming station comprising:
a first mold configured to be pressed against the at least two layers of paper material;
a second mold configured to be pressed against the at least two layers of paper material opposite the first mold;
a plurality of heating elements configured to heat the first mold and the second mold; and
an actuator configured to actuate at least one of the first mold and second mold against the at least two layers of paper material; and
a control system configured to:
activate the heating elements to heat the first mold and second mold;
instruct the actuator to actuate the at least one of the first mold and second mold against the at least two layers of paper material to apply pressure and heat to the at least two layers of paper material thereby:
melting the adhesive from a solid state to a liquid state between the at least two layers of paper material; and
shaping the at least two layers to shape the paper product; and
instruct the actuator to remove the first mold and second mold from the at least two layers of paper material so that the adhesive cools to the solid state thereby bonding the first and second layers of paper material together.

2. The system of claim 1, wherein the forming station further comprises a scoring station configured to score the at least two layers of paper material before the first mold and the second mold press against the at least two layers of paper material.

3. The system of claim 1, wherein the control system is further configured to generate an instruction to pre-laminate the at least two layers of paper material together before the first mold and the second mold press against the at least two layers of paper material.

4. The system of claim 1, wherein the control system is further configured to generate an instruction to mechanically attach the at least two layers of paper material together before the first mold and the second mold press against the at least two layers of paper material.

5. The system of claim 1, wherein some of the plurality of heating elements are positioned adjacent the first mold opposite the second mold.

6. The system of claim 5, wherein some of the plurality of heating elements are positioned adjacent the second mold opposite the first mold.

7. The system of claim 1, wherein one of the first and second molds comprises a central portion and an annular portion shiftable relative to the central portion.

8. The system of claim 1, wherein the control system is further configured to monitor and regulate temperatures of the central portion and the annular portion.

9. The system of claim 1, wherein the forming station further comprises an insulator plate positioned near one of the first and second molds to retain heat in the one of the first and second molds.

10. A method of forming a laminated paper pressware product, the method comprising steps of:
positioning at least two layers of paper material between opposing first and second molds of a forming station;
heating the opposing first and second molds;
actuating the opposing first and second molds to press against the at least two layers of paper material to apply pressure and heat to the at least two layers of paper material thereby:
melting adhesive from a solid state to a liquid state between the at least two layers of paper material; and
shaping the at least two layers to shape the paper product; and
removing the opposing first and second molds from the at least two layers of paper material so that the adhesive cools to the solid state thereby bonding the first and second layers of paper material together.

11. The method of claim 10, further comprising a step of scoring the at least two layers of paper material before the heating and actuating steps.

12. The method of claim 10, further comprising a step of pre-laminating the at least two layers of paper material together before the heating and actuating steps.

13. The method of claim 12, wherein the pre-lamination step includes pre-laminating the at least two layers of paper material together near a product center of the at least two layers of paper material.

14. The method of claim 12, wherein the pre-lamination step includes pre-laminating the at least two layers of paper material together in scrap areas of the at least two layers of paper material.

15. The method of claim 10, further comprising a step of mechanically attaching the at least two layers of paper material together before the heating and actuating steps.

16. The method of claim 10, further comprising a step of shifting a central portion of at least one of the opposing first and second molds relative to an annular portion of the at least one of the opposing first and second molds.

17. The method of claim 16, further comprising a step of regulating temperatures of the central portion and the annular portion.

18. The method of claim 10, further comprising a step of feeding the at least two layers of paper material from supply rolls via roller assemblies before the positioning step.

19. The method of claim 10, further comprising a step of coating a surface of one of the at least two layers of paper material with the adhesive before the positioning step.

20. A method of forming a laminated paper pressware product, the method comprising steps of:
feeding at least two layers of paper material from supply rolls via roller assemblies;
pre-laminating the at least two layers of paper material together;
scoring the at least two layers of paper material;
positioning the at least two layers of paper material between opposing first and second molds of a forming station;
heating the opposing first and second molds;
actuating the opposing first and second molds to press against the at least two layers of paper material to apply pressure and heat to the at least two layers of paper material thereby:
melting the adhesive from a solid state to a liquid state between the at least two layers of paper material; and
shaping the at least two layers of paper material to shape the paper product; and
removing the opposing first and second molds from the at least two layers of paper material so that the adhesive cools to the solid state thereby bonding the first and second layers of paper material together.
